(19) United States
(12) Patent Application Publication
(10) Pub. No.: US 2005/0171876 A1
(43) Pub. Date: Aug. 4, 2005

(54) Wireless asset management system

(76) Inventor: Patrick Golden, Bellingham, WA (US)

Correspondence Address: Patrick E. Golden, 3900 Bennett Avenue, Bellingham, WA, 98229, US

(21) Appl. No.: 11/049,490

(22) Filed: Feb. 1, 2005

Related U.S. Application Data
(60) Provisional application No. 60/541,186, filed on Feb. 2, 2004.
(60) Provisional application No. 60/571,076, filed on May 14, 2004.

(51) Int. Cl. G06F 17/60

(52) U.S. Cl. 705/30

(57) ABSTRACT

The present invention relates to a wireless asset management system method for the identification, monitoring, and tracking of people or objects. More specifically the invention relates to a wireless data gathering network, whereby the data is processed and delivered to a predetermined number of devices for visual or automated reading. A plurality of applications are made possible by the processing of said data, such as, but not limited to, safety, security, payroll, finance, business operations, emergency reporting and response, sensor manipulation, inventory control, physical plant controls, and system wide self-diagnostics.

### CROSS REFERENCE TO RELATED PROVISIONAL APPLICATIONS

60/541,186 “Automatic Payroll System” Feb. 2, 2004; 60/571,076 “Wireless Asset Manager” May 14, 2004.

### CITIZENSHIP—USA

### FEDERALLY SPONSORED RESEARCH

N/A

### SEQUENCE LISTING OR PROGRAM

N/A

### BACKGROUND OF THE INVENTION—FIELD OF INVENTION

This invention relates to a wireless asset management network control system, specifically one that provides location based, safety, security, financial, emergency protocol, business operations, sensing, and communication applications.

### BACKGROUND OF THE INVENTION

Commercial and industrial sites are looking for increased efficiency and effectiveness by installing systems to handle various aspects of their operations. Areas in need of a better strategy to fulfill day to day operations are asset management, safety and security, human resources, physical plant, and communications. Traditionally these systems required manual inputs and human oversight. Attempts have been made to provide technologies that address these concerns. One such strategy has been to deploy wireless systems that could benefit the end user.

Asset management deals with the ability to identify, monitor, and/or track any known item that may be valuable to anyone else. Another name for this would be inventory control. People could also be considered assets in the right setting and therefore, their position in a building or property would have importance to some. Information obtained from knowing where valuables or people are can be used to drive many other applications. One would be safety and security. Safety in a commercial or industrial setting is becoming more important everyday. The location of an object or human is valuable data during an emergency and could be used to save lives and property. Security aspects would focus on who is traveling throughout a facility or property, what are they currently doing, where are they going and where have they been, why were they allowed to go there in the first place, and how will this amount of data be mined to the best advantage of the end user? Another would be human resources. Data gathered from knowing identification, monitoring, and tracking would benefit those involved in payroll data collection to automate this part of a payroll system. Currently, workers either stamp a time card, manually keep track themselves, or log in on some networked computer system. Another would be the physical plant, or building services, department that is given the responsibility to keep the property running efficiently. An advanced system could use data gathered to automate general lighting, environmental controls, and maintenance functions. And finally, another area that could benefit from advanced data gathering would be communications. This would encompass communication between a base station and people or people dealing with other people, and in a virtual sense, machines or other inanimate objects “speaking” to those who need to know their condition.

Thereafter, inventors have created several systems and combinations of systems to develop a workable solution to address the end user's needs. U.S. Pat. No. 6,795,019 to Holt (2002) discloses a complex technology based on precise calibrations for proper location. Interference in real world applications prevent this from being a viable solution. Several solutions have been introduced using a common technology called RFID (radio frequency identification) such as U.S. Pat. No. 6,778,096 to Ward, et al (2004) deals with an RFID based system to track computers. This system is severely limited by its passive technology and lack of physically tracking the item as it is moved from one location to another. Another is U.S. Pat. No. 6,768,419 Garber, et al (2004) and their system cited and referenced for libraries. This system also lacks the ability to retrieve an items location in real time. Another popular technology used for networking with an object is GPS (global positioning system). This is referenced in U.S. Pat. No. 6,816,090 to Teckchandani, et al (2004) whereby the technology tracks mobile objects. This technology is severely limited to outdoor use and has no application indoors.

In every case this prior art lacks the flexibility of the current invention method by using hardware that is gathering location, identification, and monitoring information, mining this data, and outputting several applications that are all valuable.

### BACKGROUND OF THE INVENTION—OBJECTS AND ADVANTAGES

Several, but not limited to, objects and advantages of the present invention are:

(a) to provide a control system that comprises a network to relay and process said data;

(b) to provide a control system that gathers identification, tracking, monitoring, and calculating data;

(c) to provide a control system that uses location information to automate the gathering of payroll data, cross-billing, and billing for services to export to a payroll service or other software;

(d) to provide a control system that incorporates a user interface, either stationary or mobile, to display information graphically or in text form;

(e) to provide a control system that uses location information to interface with outside systems and services such as heating, ventilation, air conditioning, lighting, temperature controls, and humidity controls;

(f) to provide a control system that uses location information to establish efficiency and productivity patterns, studies, and plans in commercial and industrial settings;

(g) to provide a control system that calculates and reports time spent at a given location within the network;

(h) to provide a control system that will be incorporated into inventory control protocol and asset tracking;

(i) to provide a control system that incorporates an emergency stating function based on location that automates the calling and coordination of emergency personnel and equipment;

(j) to provide a control system that gathers, processes, and communicates sensor information right on a piece of equipment or on a person, taking environmental and thermal readings;

(k) to provide a control system that sends location information of remote sensors or assets to various parts of a manufacturing process;

(l) to provide a control system that shows the location and identification of people or things in real time or through archived data from a data storage device;

(m) to provide a control system that establishes an alternate form of audible communication through a network device;

(n) to provide a control system that monitors equipment life cycles to establish maintenance and replacement schedules

(o) to provide control system supporting hardware that has an on-board processor and radio transmitter/receiver, powered by alternating current or direct current means;

(p) to provide control system supporting hardware that uses an accelerometer, or motion sensor, to extend power source life;

(q) to provide control system supporting hardware that incorporates expansion slots/receptacles to accept other components or sensors as needed;

(r) to provide control system supporting hardware that combines alternative proximity or larger area wireless security techniques such as magnetic stripe, radio frequency identification labels, ultra wide band, high frequency, and bar coding with the present invention;

(s) to provide control system supporting hardware that shows evidence of tampering with a device;

(t) to provide control system supporting hardware that may be incorporated into a badge or plastic card and uses an electronic or visual means of identification to the network itself;

(u) to provide a control system that runs diagnostic programs to self monitor system hardware and software function;

(v) to provide a control system that communicates via an Intranet, the Internet, or alternative communication media;

(w) to provide a control system security and encryption protocol that allows the network to communicate without access from unwanted components or software not associated with the system;

(x) to provide a control system that houses personnel information in the network database;

(y) to provide a control system that incorporates icons to relay information using color coding, shapes, or various other alternatives

(z) to provide a control system that shows icon movement as assets or people move.

Still further objects and advantages will become apparent from a consideration of the following descriptions and drawings.

### SUMMARY

In accordance with the present invention of a method for network asset management.

### DRAWINGS—FIGURES

FIG. 1 shows the overall mesh network system

FIG. 2 shows the system flowchart

FIG. 3 shows a typical graphic display

FIG. 4 shows claimed layout

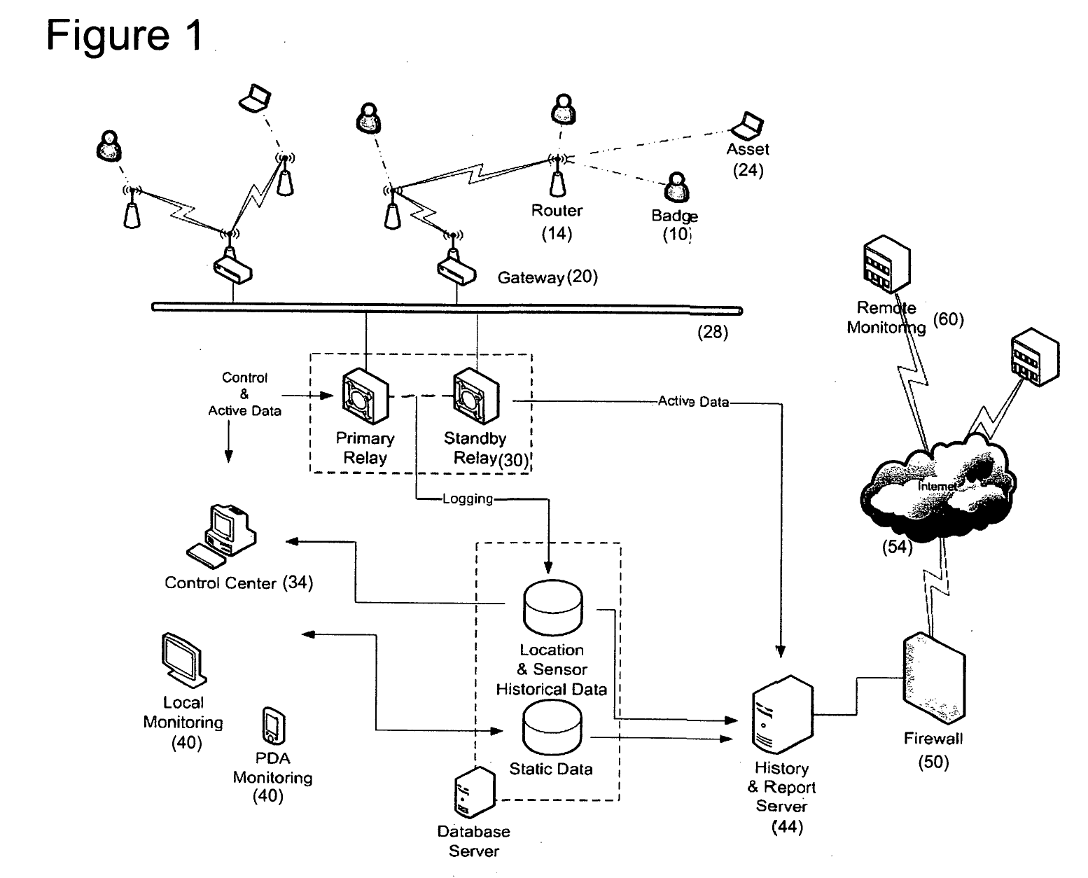

### DETAILED DESCRIPTION—FIG. 1 PREFERRED EMBODIMENT

A preferred embodiment of the overall mesh network is illustrated in FIG. 1. The system is composed of several components; one is low power data gathering device 10. Said device may be in the form of a badge, tag, or similar structure designed to be worn by a person or be located on any asset 24. Said asset 24 may be any valuable item, inventory, or any structure or component one wishes to identify, monitor, and track. Device 10 comprises a power supply, processing circuitry and on-board software located in a storage component, antenna, and enclosure. Data collected by device 10 on a person or asset 24 is communicated to router 14 where it is passed along to gateway 20. Router 14 may be powered by direct current or alternating current means and may act as the wireless or hardwired communicating media between device 10 and gateway 20. Router 14 comprises a power supply, processing circuitry and on-board software located in a storage component, antenna, and enclosure. Gateway 20 acts as a data traffic coordinator between a plurality of router 14 and the backend processing areas. Said gateway 20 comprises a power supply, processing circuitry and on-board software located in a storage component, antenna, various connectors such as, but not limited to, Ethernet, serial, wireless, and enclosure. A visual separation between the front end hardware and the backend processing area is shown as 28. Separation 28 may either be of a wireless or hardwired means. Data received from the front end hardware is delivered to primary and secondary relay 30 whereby said data coming from a plurality of gateways 20 is further coordinated for proper processing by control center 34. Said control center is a computer or plurality of computers housing the application layer software either located together or at a remote facility. Control center 34 comprises, but not limited to, a screen, internal circuitry, software, storage component, and user interface. Control center 34 processes data from the network, sends processed data to history and report server 44, and retrieves archived data from said history and report server 44. History and report server 44 houses the database or plurality of databases required to store and retrieve date. History and report server 44 comprises storage components, processing capabilities and an enclosure. To provide visual access to processed data monitoring stations 40 are required. Said monitoring stations 40 are stationary or portable user interfaces that display information graphically or in text form. Other information is used to assist the graphic or text monitoring stations 40 such as floor plans, employee records, inventory lists, icons, etc. Monitoring stations 40 may provide one way or two way communication capabilities with the network or other associated networks. Also incorporated into history and report server 44 is firewall 50. Said firewall 50 is needed for communication protection through a large area network, an intranet, or other media such as, but not limited to, Internet 54. Firewall 50 is a physical piece of hardware that provides a security buffer against undesired access to the network front end or backend. Remote monitoring stations 60 are information access devices used to access network information from a remote location away from the network. Said remote monitoring devices 60 are also used to access and manipulate control center 34 from a separate physical location.

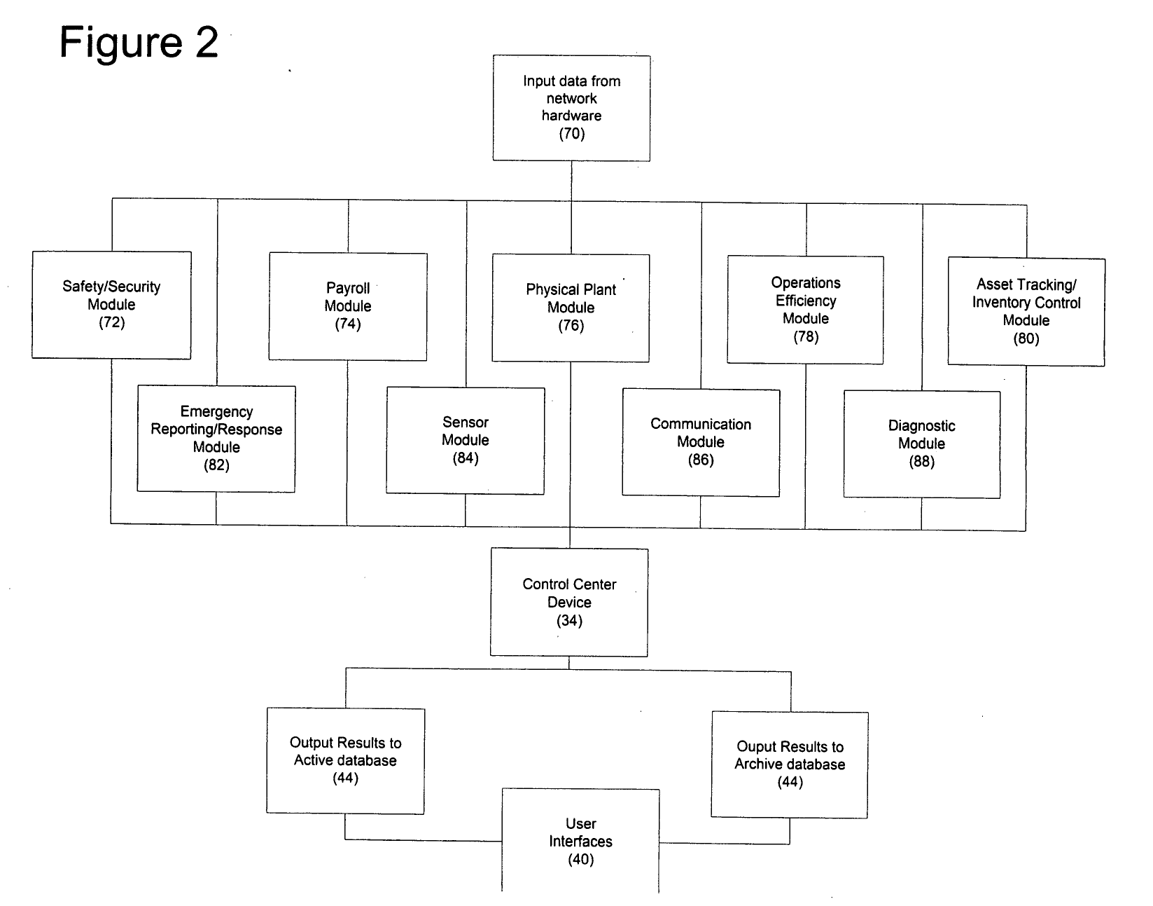

### FIG. 2—ADDITIONAL EMBODIMENTS—SOFTWARE FLOWCHART

Additional embodiments are shown in FIG. 2 as they relate to the network described above and in FIG. 1. From a software perspective, application and network layers exists in badge/tag device 10, router 14, gateway 20, control center 34, history and report server 44, and remote monitoring devices 40, 60. Input data from network hardware 70 enters into the application layer located in all associated components. Modules 72-86 control the various applications that could be enabled to function.

Safety/Security module 72 application is associated with, but not limited to, using data to establish precise location of people and things that wear badge/tag device 10. This information is further used to identify, monitor, and track people and things, report a real-time picture of a facility or property, identify, monitor, and track visitors and sub-contractors. Payroll module 74 application is associated with, but not limited to, using location data gathered to export to a payroll data processing software program. This eliminates the need for time clocks, time sheets, logging in on computers, and/or manually keeping billing records. Physical plant module 76 application is associated with, but not limited to, using gathered data for the control and manipulation of lighting fixtures, heating and air conditioning controls and fixtures, and boilers, pumps, blowers, fans, ventilators, automatic doors, heated flooring, automatic window shading and pane devices, thermal walls, wall mounted displays, processing equipment, etc. Operations efficiency module 78 application is associated with, but not limited to, using data to study archived tracking and developing efficiency reports to optimize business operations such as time to travel reports, man hours per job, down time per job, ambient air conditions and how they are used to effect manufacturing processes and equipment, record equipment use through such means as vibrations or alternative means to forecast the life expectancy of a particular piece of equipment or inventory, etc. Asset tracking/Inventory Control module 80 application is associated with, but not limited to, using gathered data to identify, monitor, and track valuable items, equipment, visitors, sub-contractors, documents, folders, inventory, furniture, parts, or finished goods. Module 80 also times badge/tag 10 presence and how long they communicate with certain routers 14. Emergency reporting/response module 82 application is associated with, but not limited to, using gathered data to report a security breech due to non-authorized asset movement, improper human access into forbidden areas, high levels of hazardous materials in a given area, automatically call for emergency personnel, transmit real-time emergency status to remote devices and personnel, show man down conditions, etc. Sensor module 84 application is associated with, but not limited to, using data gathered to process sensor readings taken on badge/tag 10, router 14, or gateway 20. These on-board sensors could be nano-scale in design or larger and gather thermal, vibration, humidity, light, stress, chemicals, and/or ambient air composition readings. The output is then relayed to appropriate components. Communication module 86 application is associated with, but not limited to, using the network infrastructure to speak or communicate in alternate ways directly to the person wearing badge/tag 10 through a speaker, buzzer, clicker, light, or other audible signal. Diagnostic module 88 application is associated with, but not limited to, using the program to run a diagnostic inspection of both the software and hardware involved in the system architecture. Such readings would monitor overall strength of signal, power level indicators in all hardware, system integrity, viruses, security breeches, spy ware, environmental condition fluctuations, etc.

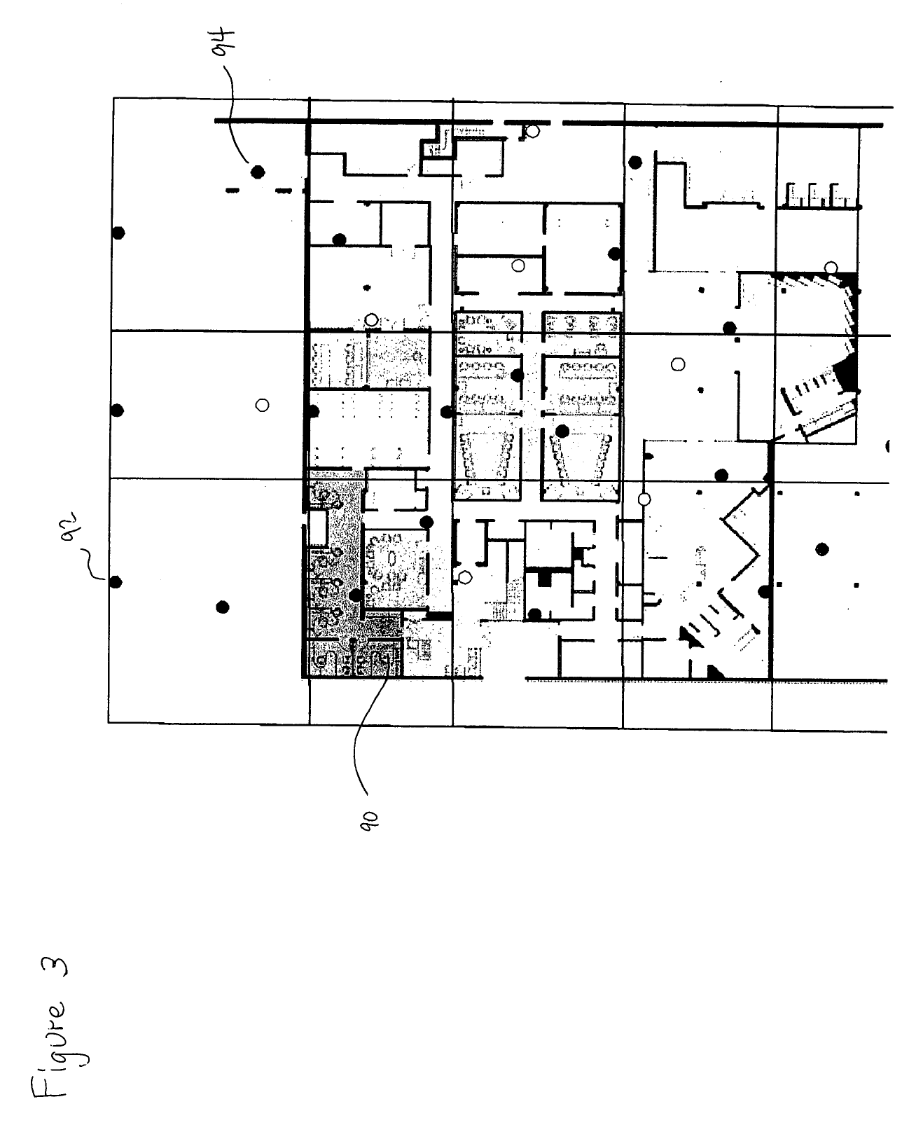

### FIG. 3—ADDITIONAL EMBODIMENTS—TYPICAL GRAPHIC DISPLAY

FIG. 3 relates to a sample graphic display of location data that has been processed and delivered to the user. Sample floor plan 90 shows a typical layout of any commercial indoor property. Router 14 placement 92 is displayed in a typical installation and shows color coding as it relates to a specific piece of network equipment. Badge tag/10 placement 94 shows the location of a specific item or person wearing a particular badge/tag 10.

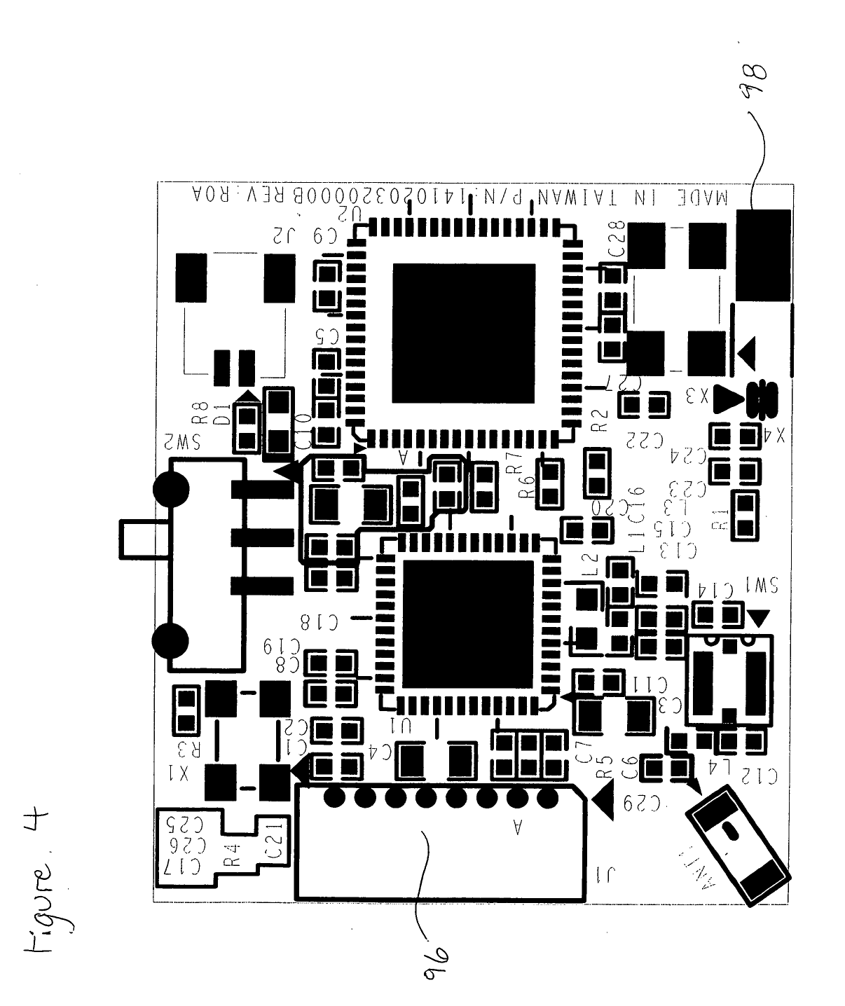

### FIG. 4—CLAIMED COMPONENT LAYOUT

FIG. 4 shows two elements of the present invention and claims made for expansion slots 96 open for future sensors or other components. Motion sensor 98 is used for prolonging power life of the board.

### OPERATION

The manner of using the control system is that a person or assets will have badge/tag 10 affixed by some means. Router 14 will be placed at strategic points to provide efficient coverage as people or assets 24 move about. Gateway 20 is placed in the vicinity of a plurality of routers 14 to coordinate data traffic reporting from routers 14. Backend standby and primary relays 30, control centers 34, history and reporting servers 44, and monitoring devices 40, 60 are all placed in vicinity or remotely to accepts data as it is delivered from the front end hardware to the backend processing components.

Badge/tag 10 transmits data to router 14. Router 14 passes on data to gateway 20. Gateway 20 passes through original processed data to the relays 30. Relays 30 pass through data to control center for further processing and deliver real-time data to monitors 40, 60 and deliver data to history server for archiving 44.

### ADVANTAGES

From the description above, a number of advantages of my method for a wireless asset management network control system become evident. This invention:

(a) to provide a control system that comprises network hardware to gather, relay and process said data;

(b) to provide a control system that gathers identification, tracking, monitoring, and calculating data;

(c) to provide a control system that uses location information to automate the gathering of payroll data, cross-billing, and billing for services to export to a payroll service or other software;

(d) to provide a control system that incorporates a user interface, either stationary or mobile, to display information graphically or in text form;

(e) to provide a control system that uses location information to interface with outside systems and services such as heating, ventilation, air conditioning, lighting, temperature controls, and humidity controls;

(f) to provide a control system that uses location information to establish efficiency and productivity patterns, studies, and plans in commercial and industrial settings;

(g) to provide a control system that calculates and reports time spent at a given location within the network;

(h) to provide a control system that will be incorporated into inventory control protocol and asset tracking;

(i) to provide a control system that incorporates an emergency stating function based on location that automates the calling and coordination of emergency personnel and equipment;

(j) to provide a control system that gathers, processes, and communicates sensor information right on a piece of equipment or on a person, taking environmental and thermal readings;

(k) to provide a control system that sends location information of remote sensors or assets to various parts of a manufacturing process;

(l) to provide a control system that shows the location and identification of people or things in real time or through archived data from a data storage device;

(m) to provide a control system that establishes an alternate form of audible communication through a network device;

(n) to provide a control system that monitors equipment life cycles to establish maintenance and replacement schedules

(o) to provide control system supporting hardware that has an on-board processor and radio transmitter/receiver, powered by alternating current or direct current means;

(p) to provide control system supporting hardware that uses an accelerometer, or motion sensor, to extend power source life;

(q) to provide control system supporting hardware that incorporates expansion slots/receptacles to accept other components or sensors as needed;

(r) to provide control system supporting hardware that combines alternative proximity or larger area wireless security techniques such as magnetic stripe, radio frequency identification labels, ultra wide band, high frequency, and bar coding with the present invention;

(s) to provide control system supporting hardware that shows evidence of tampering with a device;

(t) to provide control system supporting hardware that may be incorporated into a badge or plastic card and uses an electronic or visual means of identification to the network itself;

(u) to provide a control system that runs diagnostic programs to self monitor system hardware and software function;

(v) to provide a control system that communicates via an Intranet, the Internet, or alternative communication media;

(w) to provide a control system security and encryption protocol that allows the network to communicate without access from unwanted components or software not associated with the system;

(x) to provide a control system that houses personnel information in the network database;

(y) to provide a control system that incorporates icons to relay information using color coding, shapes, or various other alternatives

(z) to provide a control system that shows icon movement as assets or people move.

### CONCLUSIONS, RAMIFICATIONS, AND SCOPE

Accordingly, the reader will see that this invention can be used to identify, monitor, and track any asset or person. Additionally, data gathered from asset or person location may be further processed to deliver applications such as
Safety and security
Payroll data gathering and mining
Physical plant/Environmental controls
Operations efficiency and productivity reports
Asset tracking and real-time inventory control
Emergency reporting and automatic response coordination
Sensor reading delivery and manipulation
Communication capabilities between people
Self-Diagnostic capabilities to insure reliability and maximize function

Although the description above contains many specificities, these should not be construed as limiting the overall scope of the invention but as merely providing illustrations of some of the presently preferred embodiments of this invention. For example, the hardware could take various shapes, the system could be designed to function using any present or future wireless technology, the system could be used to identify other objects or perform additional duties based on the data being gathered, or the system could remove some current components and still function as described.

Thus, the scope of the invention should be determined by the following claims and their legal equivalents, rather than by the examples given.

1. A method of a wireless asset management system, comprising;
2. a predetermined data processing means;
3. a predetermined data storage means;
4. a predetermined plurality of data gathering hardware;

5. A substantial number of system applications
6. the application of claim 5 wherein data is manipulated to perform safety and security operations.
7. the application of claim 5 wherein data is manipulated to perform payroll and financial operations.
8. the application of claim 5 wherein data is manipulated to perform physical plant operations.
9. the application of claim 5 wherein data is manipulated to perform business operations functions
10. the application of claim 5 wherein data is manipulated to perform inventory control and asset management operations.
11. the application of claim 5 wherein data is manipulated to perform emergency reporting and response operations.
12. the application of claim 5 wherein data is manipulated to perform sensor operations.
13. the application of claim 5 wherein data is manipulated to perform communication operations.
14. the application of claim 5 wherein data is manipulated to perform system self-diagnostic operations.

15. A method by which a control system processes data gathered by a wireless network and presents results to a plurality of devices.

16. A method of using electronic components to increase network efficiency, comprising;
17. an accelerometer or other motion sensitive component to extend direct current power life.
18. a circuit board with expansion slots or holes to accept current size or nano-scale sensors.
